(19) United States
(12) Patent Application Publication
(10) Pub. No.: US 2025/0392231 A1
(43) Pub. Date: Dec. 25, 2025

(54) Method of Controlling Power Supply to Electric Actuator, Power System and Robot System

(71) Applicant: ABB Schweiz AG, Baden (CH)

(72) Inventor: Yang Gao, Stockholm (SE)

(73) Assignee: ABB Schweiz AG, Baden (CH)

(21) Appl. No.: 19/311,684

(22) Filed: Aug. 27, 2025

Related U.S. Application Data
(63) Continuation of application No. PCT/EP2023/055454, filed on Mar. 3, 2023.

(51) Int. Cl. H02M 7/217

(52) U.S. Cl. CPC H02M 7/217

(57) ABSTRACT

A method of controlling power supply to an electric actuator using a power system comprising a rectifier device arranged to convert input AC power from a power source to DC power, includes controlling the rectifier device in a first power mode where the rectifier device handles a plurality of phases of the input AC power or a plurality of phases derived from the input AC power; and controlling the rectifier device in a second power mode where the rectifier device handles at least one phase and fewer phases than in the first power mode.

### CROSS-REFERENCE TO RELATED APPLICATIONS

The instant application claims priority to International Patent Application No. PCT/EP2023/055454, filed Mar. 3, 2023, which is incorporated herein in its entirety by reference.

### FIELD OF THE DISCLOSURE

The present disclosure generally relates to powering electric actuators and, more particularly, to a method of controlling power supply to an electric actuator using a power system.

### BACKGROUND OF THE INVENTION

Industrial robots are widely used for various purposes. An industrial robot typically comprises a plurality of electric motors driving respective joints of the robot. The motors may be powered and controlled by output alternating current, AC, power from a robot controller. The robot controller may in turn be powered by input AC power from a power source. The robot controller may comprise a rectifier device that converts AC power to direct current, DC, power at a DC side, and an inverter device that converts DC power at the DC side to AC power for powering and controlling each motor. The robot controller may further comprise an electronic control system controlling the rectifier device and the inverter device.

US2014001165 A1 discloses a spot-welding system comprising a spot-welding robot including a plurality of motors, a welding power source and a control device. The control device comprises a converter unit, DC bus bars and a motor drive unit for driving the motors.

### BRIEF SUMMARY OF THE INVENTION

When controlling an industrial robot by a robot controller, a rectifier device of the robot controller typically handles three phases of AC power. A power source may for example provide three-phase or single-phase input AC power. In the latter case, the rectifier device may comprise a multi-phase interleaved power factor correction (PFC) rectifier where each of a plurality of interleaved circuit arrangements provides a phase, e.g., such that the rectifier device handles three phases. In any case, the rectifier device may comprise a plurality of switches that are controlled, such as by pulse-width modulation (PWM), to rectify the input AC power.

Prior art rectifier devices typically always handle three phases of AC power, regardless of the operational state of the robot. When the rectifier device handles three phases of AC power, energy consumption is relatively high, for example due to controlling the switches of the rectifier device to provide power factor correction. Although the rectifier device may be controlled in an energy efficient manner when a load demand of the robot is high, and although a relatively high energy consumption may be motivated when the load demand is high, most robots do not always operate at high load demands. Many robots have a relatively low load demand during more than 50% of the total lifetime, for example during low speed operations, during standstill or when the motors are turned off.

The present disclosure generally describes an improved method of controlling power supply to an electric actuator using a power system, an improved power system, and/or an improved robot system comprising a power system.

In one aspect, the disclosure describes selectively controlling a rectifier device of the power system in a low power mode, where the rectifier device handles relatively few phases of AC power, energy consumption can be reduced when a load demand of an electric actuator is low.

According to a first aspect, there is provided a method of controlling power supply to an electric actuator using a power system comprising a rectifier device arranged to convert input alternating current, AC, power from a power source to direct current, DC, power; the method comprising controlling the rectifier device in a first power mode where the rectifier device handles a plurality of phases of the input AC power or a plurality of phases derived from the input AC power. The method further comprises controlling the rectifier device in a second power mode where the rectifier device handles at least one phase and fewer phases than in the first power mode.

By controlling the rectifier device in the second power mode, energy consumption by the power system is reduced. The DC power provided by the rectifier device may still be sufficient for many operations of the electric actuator where a load demand is relatively low.

### BRIEF DESCRIPTION OF THE SEVERAL VIEWS OF THE DRAWING(S)

FIG. 1 schematically represents a side view of a robot system in accordance with the disclosure.

FIG. 2 schematically represents a block diagram of the robot system in accordance with the disclosure.

FIG. 3 schematically represents a rectifier device of the robot system in a first power mode in accordance with the disclosure.

FIG. 4 schematically represents the rectifier device in FIG. 3 in a second power mode.

FIG. 5 schematically represents the rectifier device in FIG. 3 in a third power mode.

FIG. 6 schematically represents a further example of a rectifier device in a first power mode in accordance with the disclosure.

FIG. 7 schematically represents the rectifier device in FIG. 6 in a second power mode.

FIG. 8 schematically represents the rectifier device in FIG. 6 in a third power mode.

FIG. 9 is a flowchart outlining general steps of a method in accordance with the disclosure.

### DETAILED DESCRIPTION OF THE INVENTION

In the following, a method of controlling power supply to an electric actuator using a power system, a power system for controlling power supply to an electric actuator, and a robot system comprising a power system and an industrial robot including an electric actuator, will be described. The same or similar reference numerals will be used to denote the same or similar structural features.

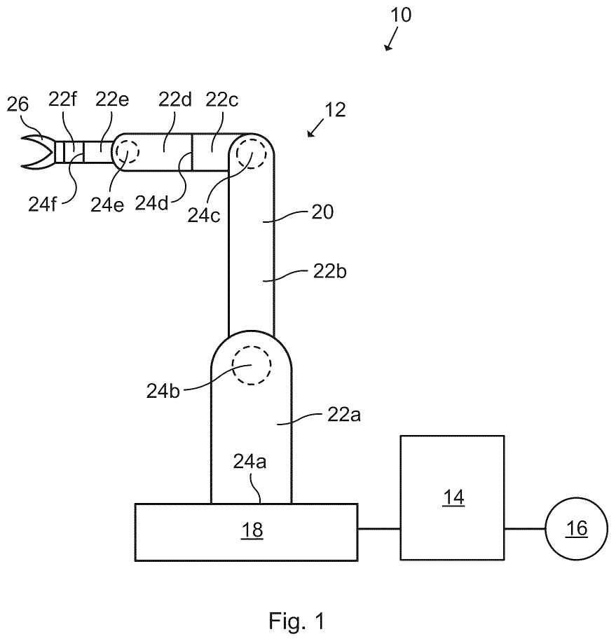

FIG. 1 schematically represents a side view of one example of a robot system 10. The robot system 10 comprises an industrial robot 12 and a robot controller 14. The robot controller 14 constitutes one example of a power system. The robot controller 14 is electrically powered by a power source 16.

The industrial robot 12 comprises a base 18 and a manipulator 20 movable relative to the base 18. The manipulator 20 of this specific and non-limiting example comprises a first link 22a rotatable relative to the base 18 at a first joint 24a, a second link 22b rotatable relative to the first link 22a at a second joint 24b, a third link 22c rotatable relative to the second link 22b at a third joint 24c, a fourth link 22d rotatable relative to the third link 22c at a fourth joint 24d, a fifth link 22e rotatable relative to the fourth link 22d at a fifth joint 24e, and a sixth link 22f rotatable relative to the fifth link 22e at a sixth joint 24f. The manipulator 20 may alternatively comprise fewer than, or more than, the six joints 24a-24f. The manipulator 20 further comprises an end effector 26 at a distal end of the manipulator 20, here at the sixth link 22f.

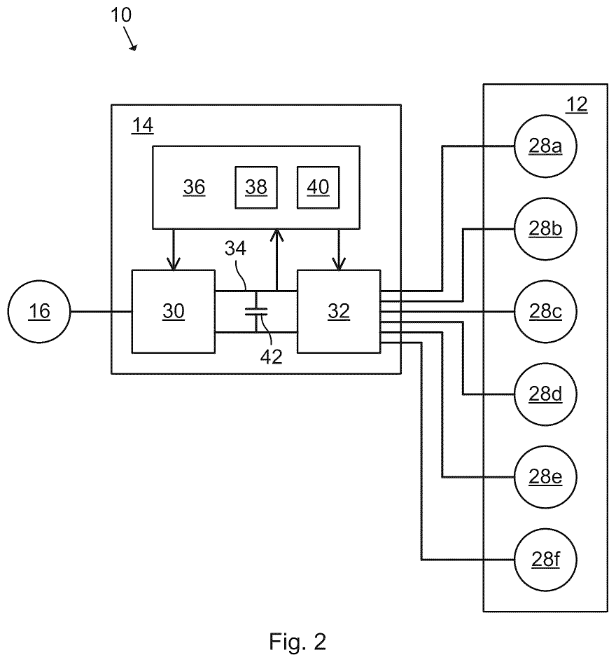

FIG. 2 schematically represents a block diagram of the robot system 10. As illustrated, the industrial robot 12 comprises a plurality of electric motors, here a first electric motor 28a for driving the first joint 24a, a second electric motor 28b for driving the second joint 24b, a third electric motor 28c for driving the third joint 24c, a fourth electric motor 28d for driving the fourth joint 24d, a fifth electric motor 28e for driving the fifth joint 24e, and a sixth electric motor 28f for driving the sixth joint 24f. The electric motors 28a-28f constitute examples of electric actuators.

The robot controller 14 of this example comprises a rectifier device 30, an inverter device 32, a direct current, DC, side 34 between the rectifier device 30 and the inverter device 32, and a control system 36. The DC side 34 is here exemplified as a DC bus.

The rectifier device 30 is arranged to convert input alternating current, AC, power from the power source 16 to DC power at the DC side 34. The inverter device 32 is arranged to convert DC power at the DC side 34 to output AC power for controlling the electric motors 28a-28f.

The control system 36 of this example comprises a data processing device 38 and a memory 40 having a computer program stored thereon. The computer program comprises program code which, when executed by the data processing device 38, causes the data processing device 38 to perform, or command performance of, various steps as described herein. The control system 36 is configured to control operations of the rectifier device 30 and the inverter device 32. Moreover, the control system 36 is powered by the DC side 34.

The robot controller 14 of this example further comprises an energy storage 42 arranged on the DC side 34. The energy storage 42 may comprise one or more capacitors.

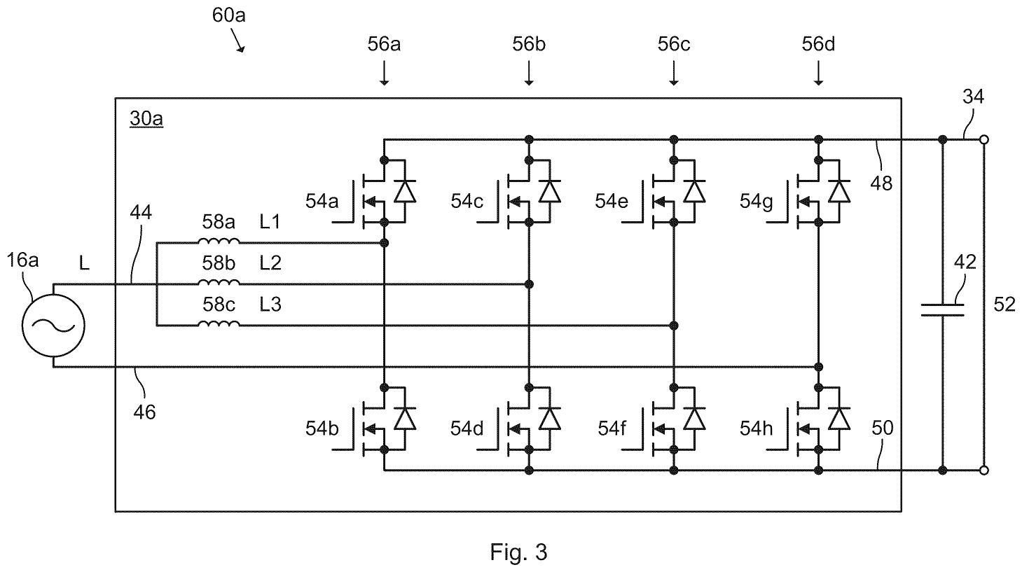

FIG. 3 schematically represents a rectifier device 30a according to one example and a power source 16a according to one example. The rectifier device 30a and the power source 16a may constitute the rectifier device 30 and the power source 16, respectively, in FIG. 2. The rectifier device 30a of this example is an active rectifier, here, a multi-phase interleaved power factor correction (PFC) rectifier. The power source 16a of this example is a single-phase power source providing a single-phase L of input AC power. The rectifier device 30a comprises a pair of input terminals 44 and 46 for receiving input AC power from the power source 16a, and a pair of output terminals 48 and 50 for supplying DC power to the DC side 34. FIG. 3 further denotes a voltage 52 on the DC side 34.

The rectifier device 30a of this example comprises a plurality of switches, here a first switch 54a, a second switch 54b, a third switch 54c, a fourth switch 54d, a fifth switch 54e, a sixth switch 54f, a seventh switch 54g and an eighth switch 54h. One, several or all of the switches 54a-54h may also be referred to with reference numeral “54”. The switches 54 may comprise any suitable switching devices, such as metal-oxide semiconductor field-effect transistors (MOSFETs).

A pair of the first switch 54a and the second switch 54b forms a first leg 56a, a pair of the third switch 54c and the fourth switch 54d forms a second leg 56b, a pair of the fifth switch 54e and the sixth switch 54f forms a third leg 56c, and a pair of the seventh switch 54g and the eighth switch 54h forms a fourth leg 56d.

The rectifier device 30a further comprises a first inductor 58a, a second inductor 58b and a third inductor 58c. The first switch 54a, the second switch 54b and the first inductor 58a form a first phase L1 handled by the rectifier device 30a, the third switch 54c, the fourth switch 54d and the second inductor 58b form a second phase L2 handled by the rectifier device 30a, and the fifth switch 54e, the sixth switch 54f and the third inductor 58c form a third phase L3 handled by the rectifier device 30a.

According to one variation of FIG. 3, the rectifier device 30a may alternatively comprise only three legs, e.g., by removing the third leg 56c and the associated third inductor 58c, to only handle two phases. According to a further variation of FIG. 3, the rectifier device 30a may alternatively comprise more than four legs, e.g., by adding one or more legs and associated inductors, to handle more than three phases.

In the rectifier device 30a in FIG. 3, the switches 54 are coupled in a multi-phase interleaved circuit arrangement between the pair of input terminals 44 and 46 and the pair of output terminals 48 and 50. The control system 36 is coupled to each switch 54. The control of the switches 54 by the control system 36 causes the single-phase L of input AC power to be interleaved or shed into the three phases L1-L3. In this way, the rectifier device 30a handles three phases L1-L3 derived from the single-phase input AC power.

The control system 36 is configured to, during a first polarity of a voltage of the input AC power, turn on and turn off the first switch 54a, the third switch 54c and the fifth switch 54e in accordance with a pulse-width modulation (PWM) signal to operate the first switch 54a, the third switch 54c and the fifth switch 54e as PFC active switches having an off-time as a function of a duty cycle of the PWM signal, while turning on and turning off the second switch 54b, the fourth switch 54d and the sixth switch 54f as synchronous switches. The first to sixth switches 54a-54f are thus switched at a relatively high frequency. The first to sixth switches 54a-54f may alternately operate as PFC active switches and as synchronous switches depending on a polarity of the voltage of the input AC power. The seventh switch 54g and the eighth switch 54h of the fourth leg 56d form a bridge that is driven at a low frequency, such as a frequency of the voltage of the AC power input, e.g., 50 Hz to 80 Hz. The rectifier device 30a in FIG. 3 may for example be of the type described in U.S. 2021226528 A1, the content of which is incorporated herein by reference.

In FIG. 3, the rectifier device 30a is controlled by the control system 36 in a first power mode 60a. In the first power mode 60a, the rectifier device 30a handles three phases L1-L3, here by high-frequency switching of the switches 54a-54f. The switching of all switches 54 is controlled such that the second phase L2 lags the first phase L1 with 120°, and the third phase L3 lags the second phase L2 with 120°.

The first power mode 60a may be used when a load demand of the industrial robot 12 is high, e.g., when moving at full speed with high payload. The maximum power output of the robot controller 14 may be 6 kW. In the first power mode 60a, the switches 54a-54f of each of the legs 56a-56c are PWM controlled at a high frequency which generates high power losses.

When the rectifier device 30a is controlled in the first power mode 60a and no power is supplied to any of the electric motors 28a-28f, the energy consumption of the robot controller 14 may for example be 200 W to 300 W, e.g., due to inductance losses and losses due to the switching of the switches 54. The power needed to power the control system 36 may however be less than 10% of this power consumption. Considering that a single plant for example may contain 1000 industrial robots 12, a total energy consumption may be considerable.

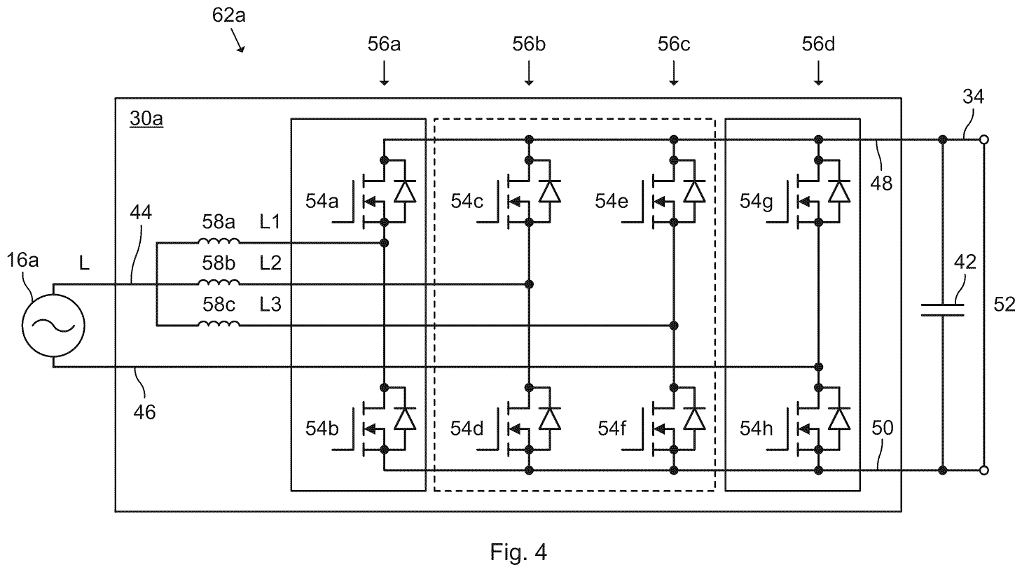

FIG. 4 schematically represents the rectifier device 30a when controlled by the control system 36 in a second power mode 62a. In the second power mode 62a of this example, the first and second switches 54a and 54b of the first leg 56a are active and controlled to switch at a high frequency (shown by a solid line box), the seventh and eight switch 54g and 54h of the fourth leg 56d are active and controlled to switch at a low frequency (shown by a solid line box), while each of the third switch 54c, the fourth switch 54d, the fifth switch 54e and the sixth switch 54f are inactive, i.e., turned off (shown by a dashed line box). Thus, in the second power mode 62a of this example, only the first phase L1 is rectified by the rectifier device 30a.

The second power mode 62a may last over a plurality of cycles of the input AC power, such as during at least one second, such as during at least one minute. Thus, in the second power mode 62a of this example, the rectifier device 30a only handles one phase, here phase L1. The rectifier device 30a thus handles fewer phases L1-L3 in the second power mode 62a than in the first power mode 60a.

In many situations the load demand is relatively low, such as during low-speed operations of the industrial robot 12, during standstill of the industrial robot 12 or when one, several or all the electric motors 28a-28f are turned off. For example, power may only be needed for the control system 36. In situations where the load demand is relatively low, it may suffice that the rectifier device 30a handles fewer phases L1-L3 than in the first power mode 60a, such as only one of the phases L1-L3. By controlling the rectifier device 30a in the second power mode 62a, energy losses can be reduced with 20% or more in comparison with the energy losses when the rectifier device 30a is controlled in the first power mode 60a. In the second power mode 62a of this example, the power output of the robot controller 14 may be reduced to a third of the maximum power output provided in the first power mode 60a.

The control system 36 is configured to provide a load demand associated with the electric motors 28a-28f. The load demand may be a current or future load demand and may for example be a collective load demand of all electric motors 28a-28f. The control system 36 is configured to compare the load demand with a first load demand threshold value. When the load demand decreases below the first load demand threshold value, the control system 36 changes the control of the rectifier device 30a from the first power mode 60a to the second power mode 62a. Conversely, when the load demand increases above the first load demand threshold value, the control system 36 changes the control of the rectifier device 30a from the second power mode 62a back to the first power mode 60a. The first load demand threshold value may be 30% of the maximum power output of the robot controller 14.

The load demand may for example be a future load demand. Since a robot program may be provided in the control system 36, the control system 36 can estimate the future load demand based on knowledge from the robot program and change a control of the rectifier device 30a from the first power mode 60a to the second power mode 62a when the load demand is estimated to be low for some time, such as at least one minute.

In the second power mode 62a, the single phase L1-L3 of the present example that is handled by the rectifier device 30a may be alternated. For example, the rectifier device 30a may handle only the first phase L1 during a first time period, only the second phase L2 during a second time period, and only the third phase L3 during a third time period. Each of the first, second and third time periods may be least one cycle of the input AC power, such as at least one second, such as at least one minute, such as at least one hour.

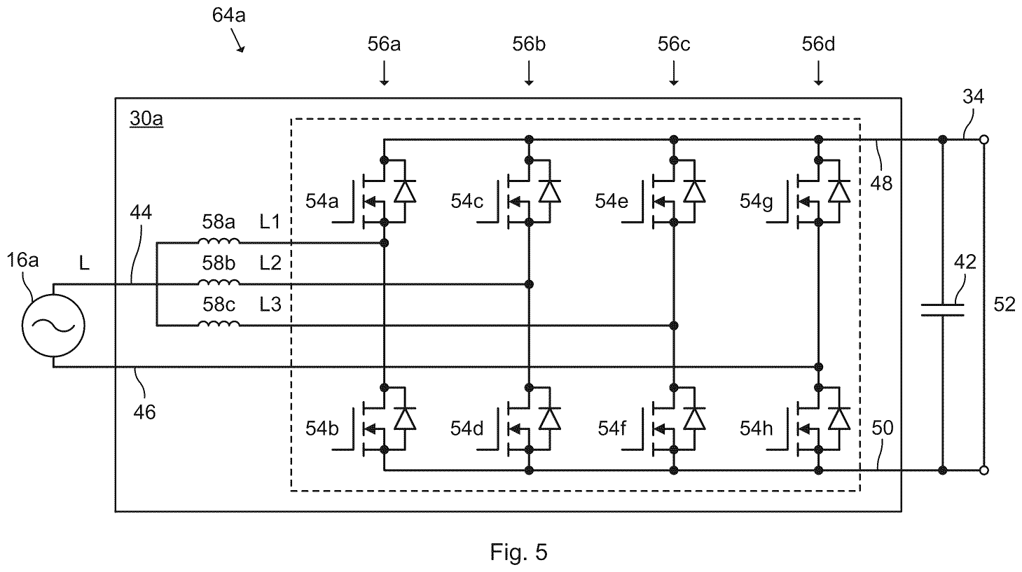

FIG. 5 schematically represents the rectifier device 30a when controlled by the control system 36 in a third power mode 64a. In the third power mode 64a of this example, all switches 54a-54h of all legs 56a-56d are inactive, i.e., turned off. Thus, in the third power mode 64a of this example, none of the phases L1-L3 is rectified by the rectifier device 30a.

The third power mode 64a may last over a plurality of cycles of the input AC power, such as during at least one second, such as during at least one minute. Thus, in the third power mode 64a of this example, the rectifier device 30a does not handle any of the phases L1-L3. The rectifier device 30a thus handles fewer phases L1-L3 in the third power mode 64a than in the second power mode 62a. The third power mode 64a will reduce power consumption even more than the second power mode 62a, for example in situations where power is only needed for the control system 36.

In the third power mode 64a, the rectifier device 30a provides power from the energy storage 42. During the third power mode 64a, the control system 36 continuously or repeatedly monitors the voltage 52 on the DC side 34.

The control system 36 is configured to compare the load demand with a second load demand threshold value. When the load demand decreases below the second load demand threshold value, the control system 36 changes the control of the rectifier device 30a from the second power mode 62a to the third power mode 64a. Conversely, when the load demand increases above the second load demand threshold value, the control system 36 changes the control of the rectifier device 30a from the third power mode 64a back to the second power mode 62a. The second load demand threshold value may for example be 10% of the maximum power output of the robot controller 14.

In addition, the control system 36 also switches from the third power mode 64a to the second power mode 62a in case the voltage 52 decreases below a voltage threshold value. In this way, the energy storage 42 can be charged. Once the voltage 52 has increased to, e.g., 10% above the voltage threshold value, the control system 36 changes the control of the rectifier device 30a from the second power mode 62a back to the third power mode 64a.

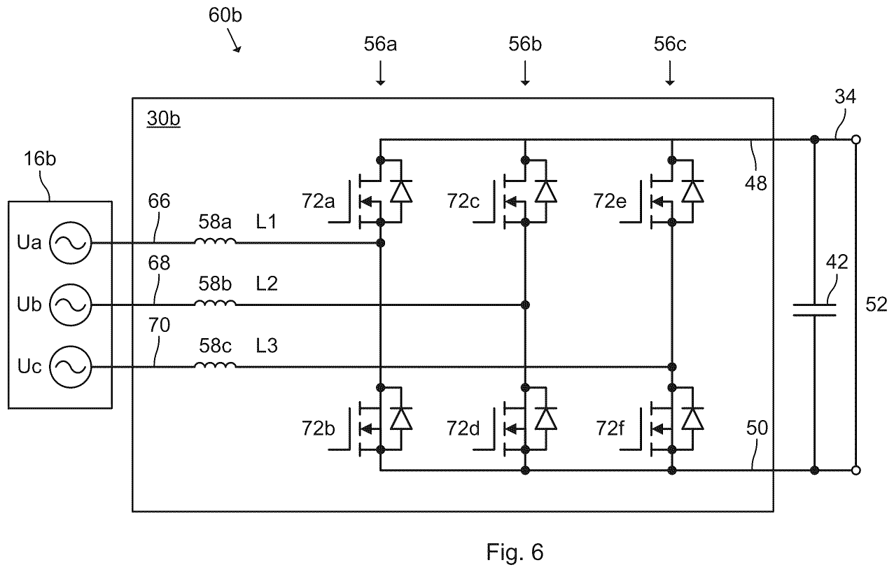

FIG. 6 schematically represents a rectifier device 30b according to a further example and a power source 16b according to a further example. The rectifier device 30b and the power source 16b may constitute the rectifier device 30 and the power source 16, respectively, in FIG. 2. The rectifier device 30b of this example is an active rectifier. Mainly differences of the rectifier device 30b with respect to the rectifier device 30a will be described.

The rectifier device 30b of this example is a three-phase six-switch boost-type PFC rectifier. The power source 16b of this example is a three-phase power source providing three phases L1-L3 of input AC power. The rectifier device 30b comprises a first input terminal 66 for the first phase L1, a second input terminal 68 for the second phase L2 and a third input terminal 70 for the third phase L3.

The rectifier device 30b of this example comprises a plurality of switches, here a first switch 72a, a second switch 72b, a third switch 72c, a fourth switch 72d, a fifth switch 72e and a sixth switch 72f. One, several or all of the switches 72a-72f may also be referred to with reference numeral “72”. The switches 72 may be of the same type as the switches 54.

In FIG. 6, the rectifier device 30b is controlled by the control system 36 in a first power mode 60b. In the first power mode 60b, the rectifier device 30b handles three phases L1-L3 of the input AC power, here, by high-frequency switching of the switches 72a-72f.

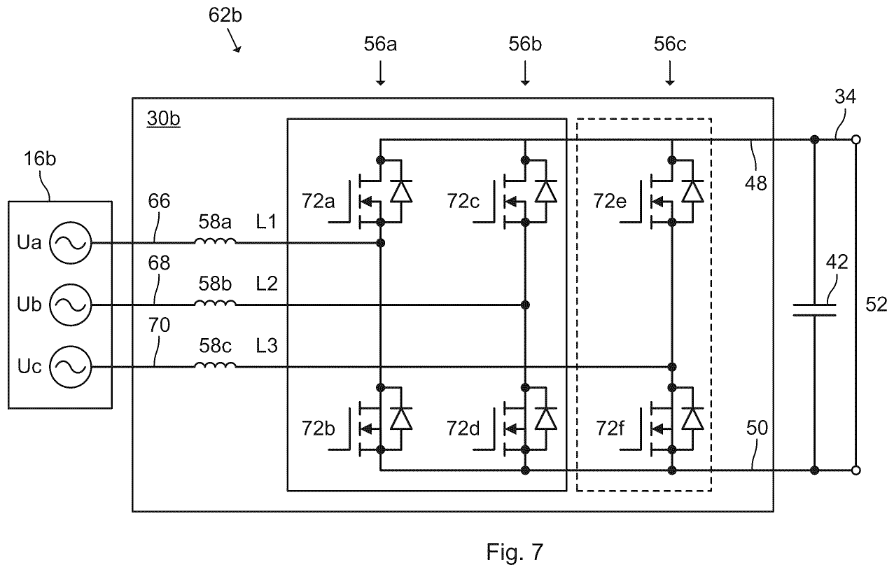

FIG. 7 schematically represents the rectifier device 30b in a further example of a second power mode 62b. In the second power mode 62b of this example, the first and second switches 72a and 72b of the first leg 56a are active and controlled to switch at a high frequency, the third and fourth switches 72c and 72d are active and controlled to switch at a high frequency, while the fifth and sixth switches 72e and 72f are inactive, i.e., turned off. Thus, in the second power mode 62b of this example, only the first and second phases L1 and L2 are rectified by the rectifier device 30b. In the second power mode 62b, the two phases phase L1-L3 that are handled by the rectifier device 30b may be alternated. For example, the rectifier device 30b may handle only the first and second phases L1 and L2 during a first time period, only the second and third phases L2 and L3 during a second time period, and only the first and third phases L1 and L3 during a third time period. Each of the first, second and third time periods may be at least one cycle of the input AC power, such as at least one second, such as at least one minute, such as at least one hour.

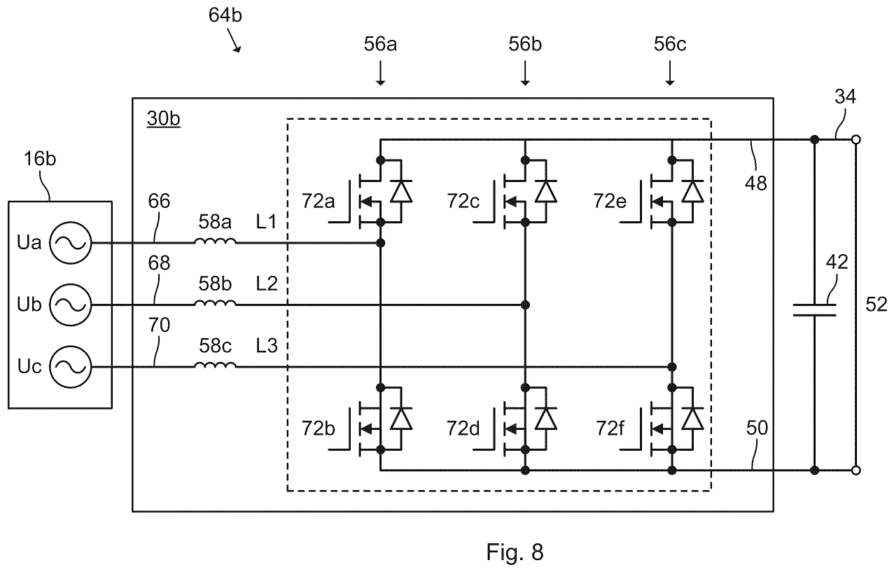

FIG. 8 schematically represents the rectifier device 30b in a further example of a third power mode 64b. In the third power mode 64b of this example, all switches 72a-72f of all legs 56a-56c are inactive, i.e., turned off. Thus, in the third power mode 64b of this example, none of the phases L1-L3 is rectified by the rectifier device 30b.

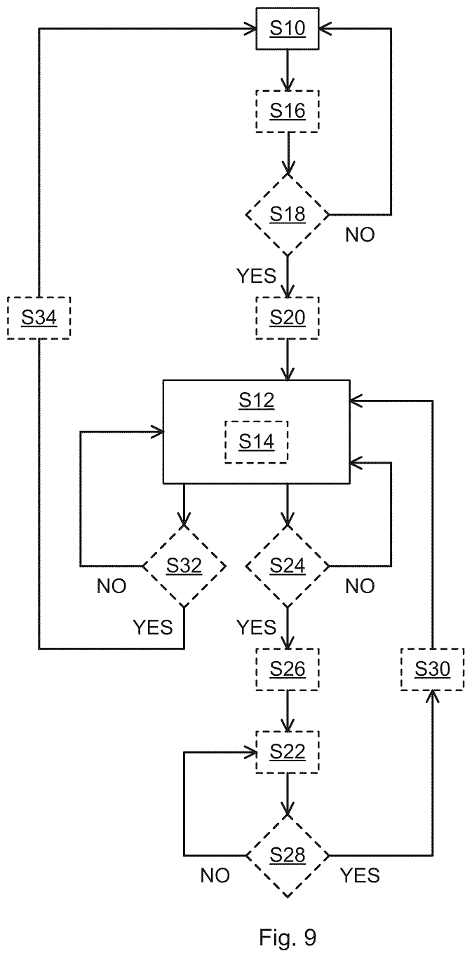

FIG. 9 is a flowchart outlining general steps of a method. The method comprises controlling S10 the rectifier device 30; 30a; 30b in the first power mode 60a; 60b where the rectifier device 30; 30a; 30b handles a plurality of phases of the input AC power or a plurality of phases derived from the input AC power. The method further comprises controlling S12 the rectifier device 30; 30a; 30b in the second power mode 62a; 62b where the rectifier device 30; 30a; 30b handles at least one phase L1-L3 and fewer phases L1-L3 than in the first power mode 60a; 60b.

The method may further comprise alternating S14 the at least one phase L1-L3 handled by the rectifier device 30; 30a; 30b in the second power mode 62a; 62b among the plurality of phases L1-L3. The method may further comprise providing S16 a load demand associated with electric motors 28a-28f. The method may further comprise comparing S18 the load demand with a first load demand threshold value when the rectifier device 30; 30a; 30b is controlled in the first power mode 60a; 60b. The method may comprise switching S20 from the first power mode 60a; 60b to the second power mode 62a; 62b upon determining that the load demand decreases below the first load demand threshold value.

The method may further comprise controlling S22 the rectifier device 30; 30a; 30b in the third power mode 64a; 64b where all phases L1-L3 handled by the rectifier device 30; 30a; 30b are deactivated and the robot controller 14 provides power from the energy storage 42 on the DC side 34 of the rectifier device 30; 30a; 30b. The method may further comprise comparing S24 the load demand with a second load demand threshold value, lower than the first load demand threshold value. The method may further comprise switching S26 from the second power mode 62a; 62b to the third power mode 64a; 64b upon determining that the load demand decreases below the second load demand threshold value.

The method may further comprise comparing S28 the voltage 52 on the DC side 34 with a voltage threshold value. The method may further comprise switching S30 from the third power mode 64a; 64b to the second power mode 62a; 62b when the voltage 52 decreases below the voltage threshold value.

The method may further comprise comparing S32 the load demand with the first load demand threshold value when the rectifier device 30; 30a; 30b is controlled in the second power mode 62a; 62b. The method may further comprise switching S34 from the second power mode 62a; 62b to the first power mode 60a; 60b upon determining that the load demand increases above the first load demand threshold value.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

In the disclosed embodiments, the power system may further comprise a DC side, such as a DC bus, arranged to receive DC power from the rectifier device, and an inverter device arranged to convert the DC power at the DC side to output AC power for controlling the electric actuator.

The power system may be used to supply power to one or several electric actuators. In any case, each electric actuator may be an electric motor.

The power system may further comprise a control system as described herein. The control system may be configured to control the rectifier device and optionally also the inverter device. The first power mode may comprise controlling the rectifier device by the control system with a first control strategy. The second power mode may comprise controlling the rectifier device by the control system with a second control strategy, different from the first control strategy.

The method may comprise controlling the rectifier device in each of the first and second power modes continuously during a plurality of cycles of the input AC power, such as during at least one second, such as during at least one minute. The first power mode and the second power mode may alternatively be referred to as a high-power mode and a low power mode, respectively.

The rectifier device may comprise an active rectifier. The active rectifier may comprise a plurality of switches that are actively controlled by the control system for providing rectification. In the first power mode, all switches may be actively controlled by the control system. In the second power mode, one or more switches may be deactivated and thus not actively controlled.

A passive rectifier may comprise a plurality of diodes. In case the rectifier device comprises a passive rectifier, the rectifier device may for example comprise one or more relays for selectively disconnecting one or more of a plurality of phases of the input AC power to switch from the first power mode to the second power mode.

The method may further comprise alternating the at least one phase handled by the rectifier device in the second power mode among the plurality of phases. In this way, wear on components of the rectifier device can be more evenly distributed and the lifetime of the rectifier device can consequently be extended. For example, if the rectifier device only handles one subject phase among a first phase, a second phase and a third phase of the input AC power during the second power mode, the subject phase may be alternatingly constituted by the first phase, the second phase and the third phase. Each alternation may for example take place each time the rectifier device enters the second power mode, or after a certain time period, such as each second, each minute, each hour or each day.

The method may further comprise providing a load demand associated with the electric actuator; comparing the load demand with a first load demand threshold value; and switching from the first power mode to the second power mode upon determining that the load demand decreases below the first load demand threshold value.

The load demand may for example be a current load demand or a future load demand associated with the electric actuator. In case the power system supplies power to a single electric actuator, the load demand associated with the electric actuator may be the load demand of this single electric actuator. In case the power system supplies power to a plurality of electric actuators, the load demand may be a load demand of one, several or all the electric actuators, such as a total load demand of all electric actuators.

The first load demand threshold value may for example be 20% to 70%, such as 30%, of a maximum power output of the power system. The first load demand threshold value may be configurable, e.g., by a programmer of the control system.

The method may further comprise controlling the rectifier device in a third power mode where all phases of the rectifier device are deactivated and the power system provides power from an energy storage on a DC side of the rectifier device. The energy storage may comprise one or more capacitors. When all phases are deactivated, the rectifier device does not provide power to the DC side. In the third power mode, the inverter device and/or the control system may be powered by the energy storage. The third power mode may be referred to as a burst mode.

The method may further comprise comparing the load demand with a second load demand threshold value, lower than the first load demand threshold value; and switching from the second power mode to the third power mode upon determining that the load demand decreases below the second load demand threshold value.

The second load demand threshold value may for example be 5% to 20%, such as 10%, of a maximum power output of the power system. Also, the second load demand threshold value may be configurable, e.g., by a programmer of the control system.

The method may further comprise comparing a voltage on the DC side with a voltage threshold value; and switching from the third power mode to the second power mode when the voltage decreases below the voltage threshold value. When the rectifier device is controlled in the third power mode and the voltage on the DC side decreases below the voltage threshold value, the control is switched to the second power mode. Once the voltage on the DC side has increased somewhat above the voltage threshold value, e.g., exceeding the voltage threshold value by at least 5%, such as by at least 10%, the control of the rectifier device may be switched from the second power mode to the third power mode.

The electric actuator may be an electric motor of an industrial robot.

According to a second aspect, there is provided a power system for controlling power supply to an electric actuator, the power system comprising a rectifier device arranged to convert input alternating current, AC, power from a power source to direct current, DC, power; and a control system comprising at least one data processing device and at least one memory having at least one computer program stored thereon, the at least one computer program comprising program code which, when executed by the at least one data processing device, causes the at least one data processing device to control the rectifier device in a first power mode where the rectifier device handles a plurality of phases of the input AC power or a plurality of phases derived from the input AC power. The at least one computer program further comprises program code which, when executed by the at least one data processing device, causes the at least one data processing device to control the rectifier device in a second power mode where the rectifier device handles at least one phase and fewer phases than in the first power mode.

The power system according to the second aspect may be of any type described in connection with the first aspect, and vice versa. The rectifier device may comprise an active rectifier. The at least one computer program may comprise program code which, when executed by the at least one data processing device, causes the at least one data processing device to perform any method described in connection with the first aspect.

According to a third aspect, there is provided a robot system comprising a power system according to the second aspect and an industrial robot including the electric actuator. The industrial robot in the third aspect may be of any type described in connection with the first and second aspects, and vice versa.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of controlling power supply to an electric actuator using a power system comprising a rectifier device arranged to convert input alternating current (AC) power from a power source to direct current (DC) power, the method comprising:
controlling the rectifier device in a first power mode where the rectifier device handles a plurality of phases of the input AC power or a plurality of phases derived from the input AC power;
controlling the rectifier device in a second power mode where the rectifier device handles at least one phase and fewer phases than in the first power mode;
providing a load demand associated with the electric actuator;
comparing the load demand with a first load demand threshold value;
switching from the first power mode to the second power mode upon determining that the load demand decreases below the first load demand threshold value;
controlling the rectifier device in a third power mode where all phases of the rectifier device are deactivated and the power system provides power from an energy storage on a DC side of the rectifier device;
comparing the load demand with a second load demand threshold value, lower than the first load demand threshold value; and
switching from the second power mode to the third power mode upon determining that the load demand decreases below the second load demand threshold value.

2. The method according to claim 1, wherein the rectifier device comprises an active rectifier.

3. The method according to claim 1, further comprising alternating the at least one phase handled by the rectifier device in the second power mode among the plurality of phases.

4. The method according to claim 1, further comprising:
comparing a voltage on the DC side with a voltage threshold value; and
switching from the third power mode to the second power mode when the voltage decreases below the voltage threshold value.

5. The method according to claim 1, wherein the electric actuator is an electric motor of an industrial robot.

6. A power system for controlling a power supply to an electric actuator, the power system comprising:
a rectifier device arranged to convert input alternating current (AC) power from a power source to direct current (DC) power;
a control system comprising at least one data processing device and at least one memory having at least one computer program stored thereon, the at least one computer program comprising program code which, when executed by the at least one data processing device, causes the at least one data processing device to:
control the rectifier device in a first power mode where the rectifier device handles a plurality of phases of the input AC power or a plurality of phases derived from the input AC power;
control the rectifier device in a second power mode where the rectifier device handles at least one phase and fewer phases than in the first power mode;
provide a load demand associated with the electric actuator;
compare the load demand with a first load demand threshold value; and
switch from the first power mode to the second power mode upon determining that the load demand decreases below the first load demand threshold value;
wherein the power system further comprises an energy storage on a DC side of the rectifier device and wherein the at least one computer program further comprises program code which, when executed by the at least one data processing device, causes the at least one data processing device to:
control the rectifier device in a third power mode where all phases of the rectifier device are deactivated and the power system provides power from the energy storage;
compare the load demand with a second load demand threshold value, lower than the first load demand threshold value; and
switch from the second power mode to the third power mode upon determining that the load demand decreases below the second load demand threshold value.

7. The power system according to claim 6, wherein the rectifier device comprises an active rectifier.

8. The power system according to claim 6, wherein the at least one computer program comprises program code which, when executed by the at least one data processing device, causes the at least one data processing device to perform a method of controlling power supply to an electric actuator using a power system comprising a rectifier device arranged to convert input alternating current (AC) power from a power source to direct current (DC) power, the method comprising:
controlling the rectifier device in a first power mode where the rectifier device handles a plurality of phases of the input AC power or a plurality of phases derived from the input AC power;
controlling the rectifier device in a second power mode where the rectifier device handles at least one phase and fewer phases than in the first power mode;
providing a load demand associated with the electric actuator;
comparing the load demand with a first load demand threshold value;
switching from the first power mode to the second power mode upon determining that the load demand decreases below the first load demand threshold value;
controlling the rectifier device in a third power mode where all phases of the rectifier device are deactivated and the power system provides power from an energy storage on a DC side of the rectifier device;
comparing the load demand with a second load demand threshold value, lower than the first load demand threshold value; and
switching from the second power mode to the third power mode upon determining that the load demand decreases below the second load demand threshold value.
